(19) United States
(12) Patent Application Publication
(10) Pub. No.: US 2014/0307234 A1
(43) Pub. Date: Oct. 16, 2014

(54) IMAGE PROJECTION APPARATUS

(71) Applicant: Mitsubishi Electric Corporation, Tokyo (JP)

(72) Inventor: Kenichiro OKURA, Tokyo (JP)

(73) Assignee: Mitsubishi Electric Corporation, Tokyo (JP)

(21) Appl. No.: 14/103,643

(22) Filed: Dec. 11, 2013

(30) Foreign Application Priority Data
Apr. 11, 2013 (JP) 2013-082617

(51) Int. Cl. G03B 21/14

(52) U.S. Cl. CPC G03B 21/145
USPC 353/119

(57) ABSTRACT

The size of an image is adjusted without changing the position of the lower side of a screen. An image projection apparatus includes an optical engine that emits image light constituting an image, and a casing having a configuration in which the optical engine is movable in a direction parallel to a path of a bottom light beam of the image light, the bottom light beam being directed toward a lower side of the screen.

### BACKGROUND OF THE INVENTION

1. Field of the Invention

The present invention relates to an image projection apparatus for projecting an image onto a screen.

2. Description of the Background Art

In recent years, image projection apparatuses such as a projector for projecting images onto a screen are finding widespread use.

For example, Japanese Patent Application Laid-Open Gazette No. 2008-158495 (FIG. 6) discloses a technique (hereinafter, also referred to as “Related Art A”) that makes it easy to adjust the size of an image to be projected. Specifically, in Related Art A, a projection engine portion that projects light constituting an image onto a screen, which is an irradiated surface, is contained in a casing. The projection engine portion is configured to be movable in a direction perpendicular to the surface of the screen. Specifically, the projection engine portion is configured to be movable in a direction parallel to the floor surface. By moving the position of the projection engine portion, the size of an image to be projected can be adjusted (varied).

In Related Art A, the projection engine portion moves within the casing. The projector itself thus does not need to be moved on a rack. In Related Art A, the image size is minimum when the projection engine portion is moved toward the screen. On the other hand, the image size is maximum when the projection engine portion is moved away from the screen.

As another example, Japanese Patent Application Laid-Open Gazette No. 2011-232416 (FIG. 6) discloses a technique (hereinafter, also referred to as “Related Art B”) that makes it easy to set the interval between a projection apparatus and a projection surface. Specifically, a projection image display system according to Related Art B includes a projection apparatus and a projection distance setting means.

The projection apparatus houses a projection unit that emits image light and an electric circuit portion. The projection distance setting means determines the interval (projection distance) between the projection apparatus and a projection surface. The projection distance setting means includes two or more projection distance setting mechanisms, each constituted by a pair of rigid members connected to make the angle therebetween variable. In Related Art B with the above-described configuration, the projection apparatus is installed by causing the front ends of the projection distance setting mechanisms to abut against a screen member. This makes it easy to install the projection apparatus at an appropriate projection distance.

In Related Art B, the angle of connection between each pair of rigid members in the projection distance setting means is made variable. This makes the position of the projection apparatus relative to the screen member variable. Specifically, each pair in the projection distance setting means allows the projection apparatus to be movable in a direction perpendicular to the projection surface, similarly to Related Art A. The projection distance setting means allows the projection apparatus to be movable in a direction parallel to the floor surface.

Accordingly, the size of an image to be projected onto the projection surface can be adjusted (varied). The size of an image on the projection surface is minimum when the projection apparatus is moved toward the screen member such that the back of the projection apparatus is connected to the screen member. On the other hand, the size of an image on the projection surface is maximum when the projection apparatus is moved away from the screen member.

As yet another example, Japanese Patent Application Laid-Open Gazette No. 2009-069572 discloses a technique (hereinafter, also referred to as “Related Art C”) that makes it easy to adjust the size of an image projected onto the projection surface. Specifically, the projector apparatus according to Related Art C includes a projection surface and a projector. The projector is disposed perpendicular to the projection surface by a connecting member provided between the projection surface and the projector. In Related Art C, the size of an image projected onto the projection surface is adjustable by the connecting member. The connecting member is formed by a combination of two members.

In Related Art C, the projector is installed at an intersection of holes provided respectively in the two members. The position of the intersection can be changed in stages depending on the combination of the positions of the holes. In other words, the distance from the projection surface to the intersection of the connecting members is adjustable. Accordingly, the size of an image projected from the projector onto the projection surface can be adjusted.

Related Arts A, B, and C, however, have the following problems. For example, in Related Art A, a convex aspherical mirror is contained in the projection engine portion and used to widen the angle of light from a projection lens. Also, as described above, the projection engine portion is configured to be movable in the direction parallel to the floor surface.

Thus, when the projection engine portion is moved away from the screen to increase the image size, the position of a light beam bound for the bottom of the screen from the aspherical mirror also moves upward (to a higher level). Following this, the top of the image also moves upward (to a higher level). For this reason, when the screen is changed from a small size to a large size, the large-size screen needs to be installed at a high level. In other words, there is a problem with Related Art A that the screen needs to be installed such that the lower side of the screen is located at a higher level with increasing image size.

In Related Art B, similarly to Related Art A, each pair of rigid members in the projection distance setting means allows the projection apparatus to be movable in the direction perpendicular to the projection surface. The projection distance setting means also allows the projection apparatus to be movable in the direction parallel to the floor surface. Accordingly, Related Art B also has a similar problem as described above for Related Art A.

In Related Art C as well, the connecting members allows the projector to be movable in the direction perpendicular to the projection surface, as with Related Art A. Specifically, the projector is configured to be movable in the direction parallel to the floor surface. Accordingly, Related Art C also has a similar problem as described above for Related Art A.

### SUMMARY OF THE INVENTION

It is an object of the present invention to provide an image projection apparatus capable of adjusting the size of an image without changing the position of the lower side of a screen.

An image projection apparatus according to an embodiment of the present invention projects an image onto a screen. The image projection apparatus includes an optical engine that emits image light constituting the image, and a casing having a configuration in which the optical engine is movable in a direction parallel to a path of a bottom light beam of the image light, the bottom light beam being directed toward a lower side of the screen.

According to the present invention, the image projection apparatus includes the optical engine that emits image light constituting the image, and the casing having a configuration in which the optical engine is movable in the direction parallel to a path of a bottom light beam of the image light, the bottom light beam being directed to a lower side of the screen. Thus, the position of the lower side of an image to be projected onto the screen remains unchanged even if the optical engine is moved. Accordingly, it is possible to adjust the size of the image without changing the position of the lower side of the screen.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows side views of an image projection apparatus according to a first embodiment of the present invention.

FIG. 2 is a rear view of the image projection apparatus according to the first embodiment of the present invention.

FIG. 3 is an exploded perspective view of the image projection apparatus according to the first embodiment of the present invention.

FIG. 4 is a side view of an image projection mechanism according to the first embodiment of the present invention.

FIG. 5 is a side view showing a configuration for moving an optical engine within a casing of the image projection apparatus.

FIG. 6 is a side view of the image projection apparatus for illustrating a mechanism for adjusting the size of a projection image.

FIG. 7 is a perspective view of an image projection apparatus according to a second embodiment of the present invention.

FIG. 8 shows side views of the image projection apparatus according to the second embodiment of the present invention.

FIG. 9 shows side views of the image projection apparatus for illustrating a mechanism for adjusting the size of a projection image.

### DESCRIPTION OF THE PREFERRED EMBODIMENTS

Hereinafter, embodiments of the present invention will be described with reference to the accompanying drawings. In the following description, the same constituent elements are denoted by the same reference numerals. The names and functions of these constituent elements are also the same. Accordingly, the detailed description thereof may be omitted.

It should be noted that the dimensions, materials, and shapes of the constituent elements illustrated as examples in the followings embodiments, as well as the relative arrangements thereof may be appropriately changed depending on various conditions and the configuration of an apparatus to which the present invention is applied, and the present invention is not limited to these examples. In addition, the dimensions of the constituent elements in the drawings may be different from their actual dimensions.

### First Embodiment

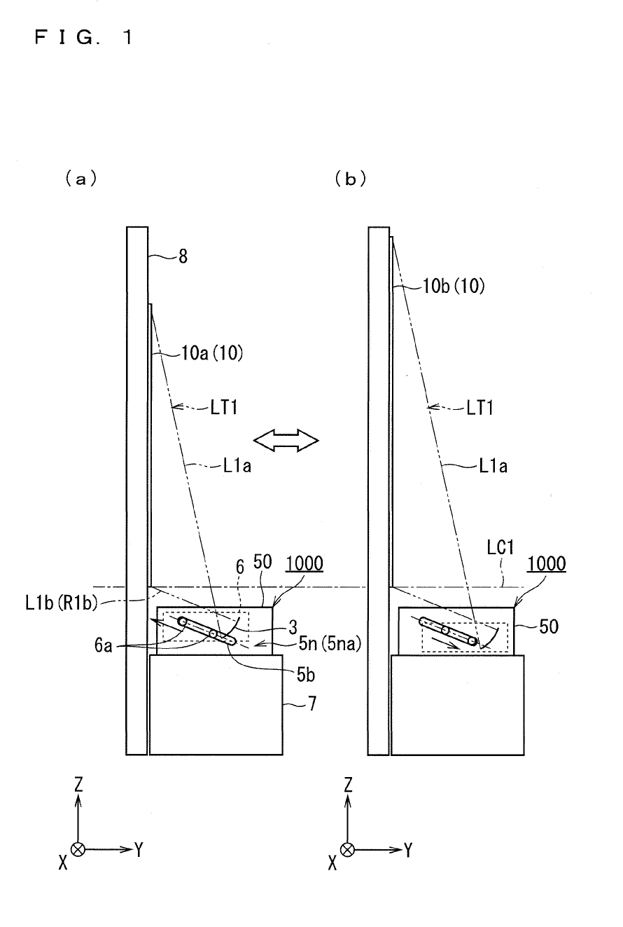

FIG. 1 shows side views of an image projection apparatus 1000 according to a first embodiment of the present invention. In FIG. 1, X, Y, and Z directions are orthogonal to one another. The X, Y, and Z directions in the following drawings are also orthogonal to one another. Hereinafter, a direction that includes both the X direction and a direction opposite to the X direction (−X direction) is also referred to as an “X-axis direction”. A direction that includes both the Y direction and a direction opposite to the Y direction (−Y direction) is hereinafter also referred as a “Y-axis direction,” and a direction that includes both the Z direction and a direction opposite to the Z direction (−Z direction) is hereinafter also referred to as a “Z-axis direction.” A plane that includes both of the X-axis direction and the Z-axis direction is hereinafter also referred to as an “XZ plane”.

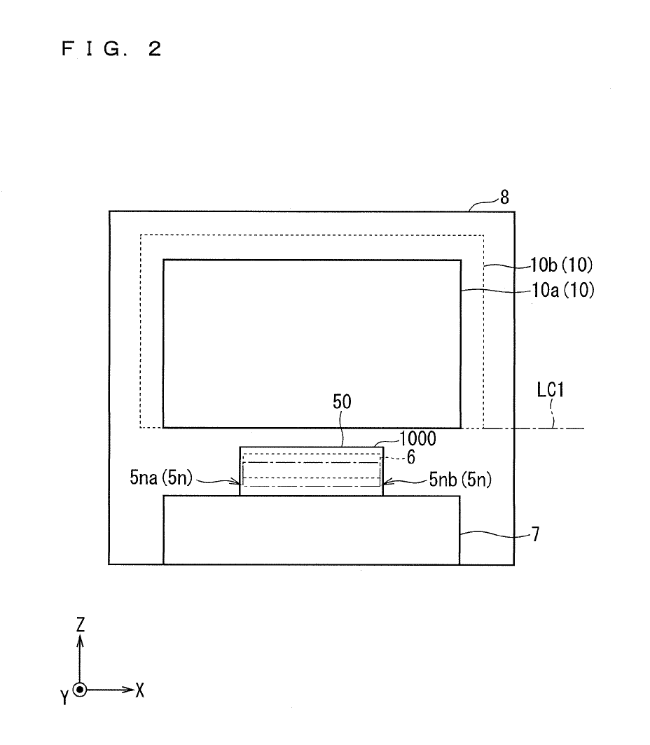

FIG. 2 is a rear view of the image projection apparatus 1000 according to the first embodiment of the present invention. For the purpose of illustration, FIGS. 1 and 2 also show, for example, screens 10a and 10b, a rack 7, and a wall surface 8 that are not included in the image projection apparatus 1000. For the sake of simplification, a top panel 12 and a front panel 13, which will be described later, are not shown in FIGS. 1 and 2.

The size of the screen 10b is greater than that of the screen 10a. Hereinafter, each of the screens 10a and 10b is also collectively denoted as a “screen 10”. The screen 10 is, for example, a reflective screen that reflects light.

Part (a) in FIG. 1 is a side view of the image projection apparatus 1000 that projects image light LT1 onto the screen 10a. The image light LT1 is light constituting an image. Part (b) in FIG. 1 is a side view of the image projection apparatus 1000 that projects the image light LT1 onto the screen 10b. FIG. 2 shows both of the screens 10a and 10b in order to clearly illustrate the sizes of the screens 10a and 10b. Note that one of the screens 10a and 10b is actually installed on the wall surface 8.

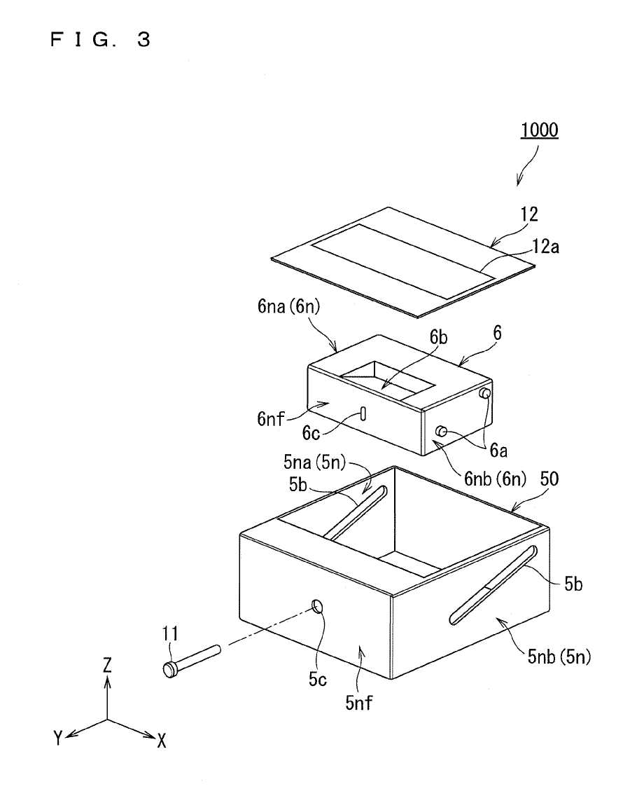

FIG. 3 is an exploded perspective view of the image projection apparatus 1000 according to the first embodiment of the present invention.

Referring to FIGS. 1, 2, and 3, the image projection apparatus 1000 is installed on the rack 7. The screen 10 is installed on the wall surface 8. The image projection apparatus 1000 projects an image onto the screen 10, the details of which will be described later.

The image projection apparatus 1000 includes the top panel 12, the front panel 13, a casing 50, and an optical engine 6. The top panel 12 and the front panel 13 will be described in detail later.

The optical engine 6 radially emits the image light LT1 constituting an image. The image light LT1 is light in an area defined by a light beam L1a, a light beam L1b, and the screen 10. The light beam L1a is a top light beam of the image light LT1 in the XZ plane (vertical direction). The light beam L1b is a bottom light beam of the image light LT1 in the XZ plane. In other words, the light beam L1b is a bottom light beam of the image light LT1 that is directed toward the lower side of the screen 10. The lower side of the screen 10 is located at a position LC1 shown in FIGS. 1 and 2. Hereinafter, the path of the light beam L1b is also referred to as a “path R1b.”

The casing 50 houses the optical engine 6. The casing 50, the details of which will be described below, is configured such that the optical engine 6 is movable in a direction parallel to the path R1b of the light beam L1b. The optical engine 6 includes (is equipped with) an image projection mechanism 100. The image projection mechanism 100 emits the image light LT1.

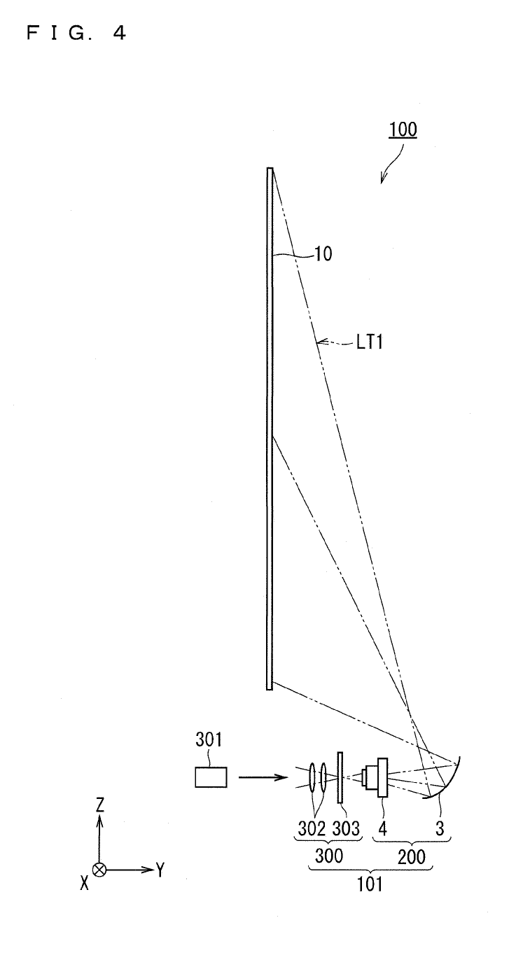

Next, the configuration of the image projection mechanism 100 will be described. FIG. 4 is a side view of the image projection mechanism 100 according to the first embodiment of the present invention. For better understanding of the configuration, FIG. 4 also shows the screen 10, which is not included in the image projection mechanism 100.

Referring to FIG. 4, the image projection mechanism 100 includes a light source portion 301 and a projection unit 101. As described above, the optical engine 6 includes the image projection mechanism 100. That is, the optical engine 6 includes the projection unit 101 included in the image projection mechanism 100.

The light source portion 301 is a light source that emits light. Examples of the light source portion 301 include a lamp light source, a laser light source, and a light emitting diode (LED) light source.

The projection unit 101 includes a projection optical unit 200 and an illumination optical unit 300. The illumination optical unit 300 includes lenses 302 and an image forming element 303. The lenses 302 collect the light emitted from the light source portion 301. The image forming element 303 is an element that modulates the intensity of the light applied to the image forming element 303 to generate image light. The image forming element 303 generates image light by transmitting or reflecting the light applied thereto.

The image forming element 303 is, for example, a liquid crystal element or a digital micromirror device (DMD). The image forming element 303 has an irradiation surface to which light is applied. The irradiation surface has a structure that generates image light that is rotationally symmetric about the optical axis relative to the irradiation surface. Note that the structure of the irradiation surface is not limited to the structure that generates rotationally symmetric image light, and the irradiation surface may have different structures.

The projection optical unit 200 includes a projection lens 4 and an aspherical mirror 3. The projection lens 4 expands light, and the aspherical mirror 3 reflects light.

Next is a description of the configuration in which the image projection mechanism 100 (the projection unit 101) emits the image light LT1. First, the light emitted from the light source portion 301 is applied to the image forming element 303 through the lenses 302. The image forming element 303 generates image light by modulating the intensity of the light applied thereto. The image light is expanded by the projection lens 4, and the expanded image light is reflected by the aspherical mirror 3. The reflected image light is output from the image projection mechanism 100 (the projection unit 101) as the image light LT1. That is, the image projection mechanism 100 (the projection unit 101) emits the image light LT1. The image light LT1 is projected onto the screen 10.

Next, the configuration of the image projection apparatus 1000 and the configurations of the casing 50 and the optical engine 6 included in the image projection apparatus 1000 will be described in detail.

Referring to FIG. 3, at the top of the optical engine 6 is provided a projection window portion 6b. The projection window portion 6b is, for example, a transparent member that transmits light therethrough.

The image light emitted from the projection unit 101 passes through the projection window portion 6b and is emitted to the outside of the optical engine 6. If dust enters the interior of the optical engine 6, the dust will appear as a defect in a projected image. Thus, the optical engine 6 has a sealed structure that prevents the entry of dust into the optical engine 6.

The top panel 12 is attached to the top surface of the optical engine 6. The top panel 12 is provided with a transparent portion 12a. The image light emitted from the optical engine 6 (the projection window portion 6b) passes through the transparent portion 12a and is projected onto the screen 10 as the image light LT1. With the above-described configuration, the image projection apparatus 1000 projects the image light LT1.

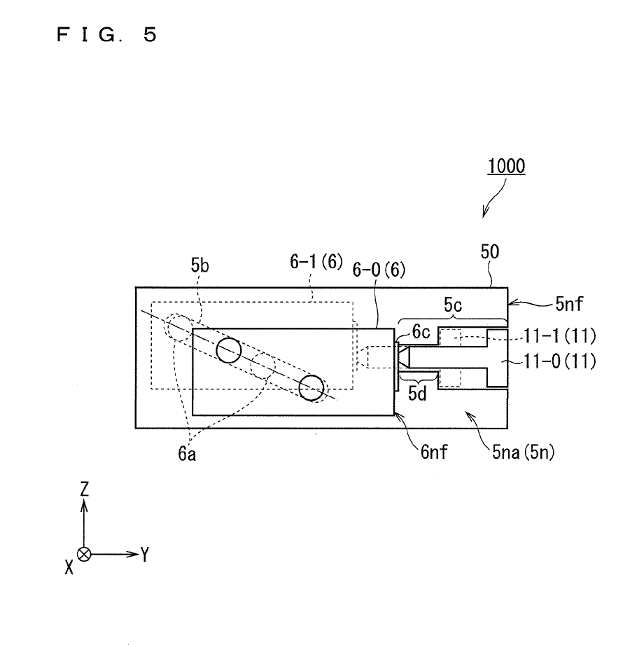

FIG. 5 is a side view showing a configuration for moving the optical engine 6 within the casing 50 of the image projection apparatus 1000. For the sake of simplification, the top panel 12 is not shown in FIG. 5.

The casing 50 has a substantially box-like shape as shown in FIGS. 2, 3, and 5. The casing 50 has a front surface 5nf and side surfaces 5na and 5nb. The side surfaces 5na and 5nb are each provided with an elongated hole 5b. The elongated holes 5b are provided extending in a direction parallel to the path R1b of the light beam L1b. Hereinafter, each of the side surfaces 5na and 5nb is also collectively denoted as a “side surface 5n”.

As described above, the casing 50 houses the optical engine 6. Referring to FIG. 3, the optical engine 6 has a substantially box-like shape. The optical engine 6 has a front surface 6nf and side surfaces 6na and 6nb. The side surfaces 6na and 6nb are each provided with two rod-like members 6a. In other words, the optical engine 6 is provided with the rod-like members 6a. Hereinafter, each of the side surfaces 6na and 6nb is also collectively denoted as a “side surface 6n”.

As shown in FIG. 1, the rod-like members 6a are provided so as to be inserted into the holes 5b of the side surfaces 5n. That is, the rod-like members 6a of the optical engine 6 fit in the holes 5b of the casing 50.

Specifically, the rod-like members 6a are provided so as to be movable in the direction of extension of the holes 5b. For example, the rod-like members 6a of the side surface 6nb are provided so as to be movable in the direction of extension of the holes 5b of the side surface 5nb. That is, the holes 5b serve as an elongated guide mechanism for guiding the direction of movement of the rod-like members 6a. As described above, the rod-like members 6a are inserted into the holes 5b. That is, the rod-like members 6a serve as a guided mechanism for, in cooperation with the holes 5b serving as the guide mechanism, allowing the optical engine 6 to be movable in the direction of extension of the guide mechanism (the holes 5b).

With the above-described configuration, the optical engine 6 is configured to be movable in a stable manner in the direction of extension of the holes 5b.

As described above, the elongated holes 5b are provided extending in the direction parallel to the path R1b of the light beam L1b. The rod-like members 6a are provided so as to be movable in the direction of extension of the holes 5b of the side surfaces 5n. Accordingly, as shown in FIG. 5, the optical engine 6 is movable in a direction parallel to the path R1b of the light beam L1b. That is, as described above, the casing 50 is configured such that the optical engine 6 is movable in the direction parallel to the path R1b of the light beam L1b.

Part (a) in FIG. 1 shows a state (hereinafter, also referred to as a “state N1”) in which the optical engine 6 has moved toward the wall surface 8. In the state N1, the distance between the wall surface 8 and the optical engine 6 is the shortest. The size of the image light LT1 (image) projected onto the screen 10 is the smallest in the state N1.

Hereinafter, the image light LT1 (image) projected onto the screen 10 is also simply referred to as a “projection image.” The size of the projection image is hereinafter also simply referred to as a “projection image size,” and the projection image size in the state N1 is hereinafter also referred to as a “minimum size.” The size of the screen 10a in part (a) in FIG. 1 corresponds to the minimum size. For example, the size of the screen 10a is equivalent to the minimum size.

Part (b) in FIG. 1 shows a state (hereinafter, also referred to as a “state N0”) in which the optical engine 6 has moved to a position that is farthest away from the wall surface 8. In the state NO, the distance between the wall surface 8 and the optical engine 6 is the longest. The projection image size on the screen 10 is the largest in the state NO.

Hereinafter, the projection image size in the state NO is also referred to as a “maximum size.” The size of the screen 10b in part (b) in FIG. 1 corresponds to the maximum size. For example, the size of the screen 10b is equivalent to the maximum size.

The optical engine 6 is, as shown in FIG. 5, configured to be movable in the range between the state N1 and the state N0. The projection image size is also adjustable according to the movement of the optical engine 6. Note that the size of the transparent portion 12a described above is set to be a size that allows the passage of the image light emitted from the optical engine 6 (the projection window portion 6b) irrespective of whether the optical engine 6 is in the state N1 or the state NO.

Next, a method for moving the position of the optical engine 6 will be described. Referring to FIGS. 3 and 5, the casing 50 has a hole 5c in its front surface 5nf. The hole 5c is for insertion of an adjustment member 11. The adjustment member 11 is a member for adjusting the position of the optical engine 6. In other words, the adjustment member 11 is a member for adjusting the projection image size. One example of the adjustment member 11 is a screw.

Hereinafter, the adjustment member 11 in the above state N1 is also denoted as an “adjustment member 11-1,” and the optical engine 6 in the above state N1 is also denoted as an “optical engine 6-1.” Also, the adjustment member 11 in the above state N0 is hereinafter also denoted as an “adjustment member 11-0,” and the optical engine 6 in the above state NO is hereinafter also denoted as an “optical engine 6-0.”

As shown in FIG. 5, the hole 5c includes a hole 5d having a smaller diameter than that of the hole 5c. The hole 5d is a hole through which the end of the adjustment member 11 is inserted. That is, the hole 5d is a hole for use in fixing the adjustment member 11.

The optical engine 6 further includes a protruding portion 6c. The protruding portion 6c is provided on the front surface 6nf of the optical engine 6. The end of the adjustment member 11 is brought into contact with the protruding portion 6c. That is, the casing 50 is provided with the hole 5c through which the adjustment member 11 is brought into contact with the optical engine 6 from outside of the casing 50.

It is assumed that an operation of, for example, rotating the adjustment member 11-0 clockwise from the front surface 5nf side of the casing 50 has been performed by the user using a driver or the like. This causes the front surface 6nf (the protruding portion 6c) of the optical engine 6-0 to be pushed by the end of the adjustment member 11-0. Accordingly, the optical engine 6-0 is moved in the direction of extension of the holes 5b. Note that the optical engine 6-0 is movable until the rod-like member 6a on the rear side come into contact with the ends of the holes 5b on one side.

That is, in FIG. 5, the optical engine 6-0 is moved to the position of the optical engine 6-1 by the user moving the adjustment member 11-0 to the position of the adjustment member 11-1, using a driver or the like.

It is also assumed that an operation of, for example, rotating the adjustment member 11-1 counterclockwise has been performed by the user using a driver or the like. This causes the end of the adjustment member 11-1 to move in the direction of the front surface 6nf. Accordingly, the optical engine 6-1 being in contact with the end of the adjustment member 11-1 moves in the direction of the front surface 6nf along the holes 5b by its own weight. Note that the optical engine 6-1 can be moved until the rod-like member 6a on the front side come into contact with the ends of the holes 5b on the other side.

Specifically, in FIG. 5, the optical engine 6-1 is moved to the position of the optical engine 6-0 by the user moving the adjustment member 11-1 to the position of the adjustment member 11-0 (i.e., loosening the adjustment member 11-1), using a driver or the like.

As described above, the hole 5c formed in the front surface 5nf of the casing 50 enables the user to access the optical engine 6 from the front of the image projection apparatus 1000, using a driver or the like. It is assumed here that, in the state N1, the operation of moving the adjustment member 11-1 to the position of the adjustment member 11-0 (i.e., loosening the adjustment member 11-1) is performed by the user using a driver or the like. In this case, the optical engine 6 moves in the direction of the front surface 6nf along the holes 5b by its own weight. That is, the position of the optical engine 6 (i.e., the projection image size) can be adjusted through a simple operation of loosening the adjustment member 11. Accordingly, it is possible to simplify the mechanism for adjusting the projection image size in the image projection apparatus 1000. As a result, it is possible to reduce the cost required for adjusting the projection image size.

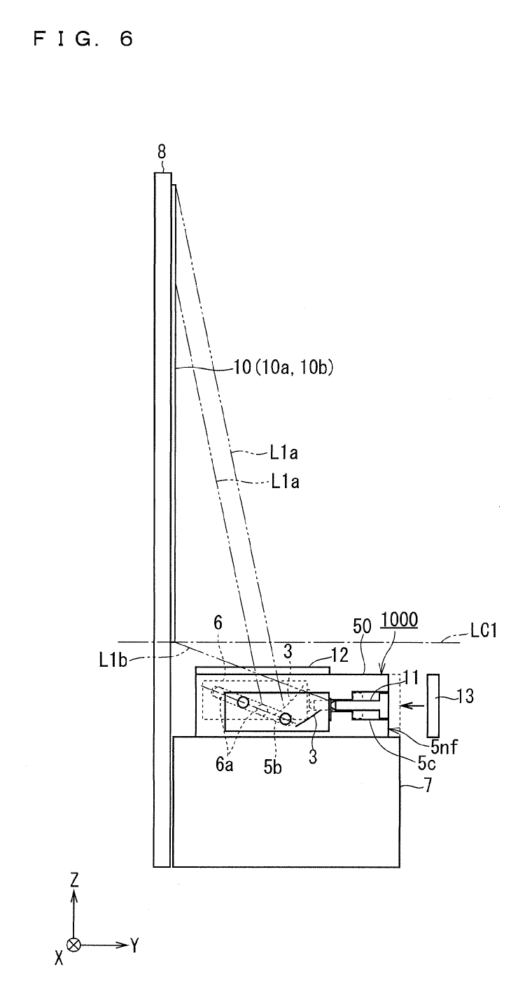

FIG. 6 is a side view of the image projection apparatus 1000 for illustrating the mechanism for adjusting the projection image size. As described with reference to FIG. 5, the optical engine 6 is moved by the rod-like members 6a in the direction of extension of the holes 5b by the user rotating the adjustment member 11 either clockwise or counterclockwise using a driver or the like. This causes a change in the distance from the optical engine 6 to the wall surface 8 and accordingly changes the size of an image to be projected onto the screen 10, which is installed on the wall surface 8.

It is thus possible to adjust the position of the optical engine 6 within the movable range of the optical engine 6. In other words, the projection image size is adjustable. Thus, an optimal image can be obtained by installing the screen 10 corresponding to that projection image size on the wall surface 8.

Note that as shown in FIG. 6, the front panel 13 is attached to the front surface 5nf of the casing 50 so as to cover the hole 5c. Accordingly, the adjustment member 11 can be covered with the front panel 13 after adjustment of the projection image size. This enhances design quality of the image projection apparatus 1000. Note that, in the case of adjusting the projection image size, the front panel 13 can be removed so that the user can access the adjustment member 11, using a driver or the like.

As described above, the image projection apparatus 1000 according to the present embodiment includes the optical engine 6 that emits the image light LT1 constituting an image, and the casing 50 configured such that the optical engine 6 is movable in the direction parallel to the path R1b of the bottom light beam L1b of the image light LT1, the bottom light beam being directed toward the lower side of the screen 10. Accordingly, the position of the lower side of an image to be projected onto the screen 10 remains unchanged even if the optical engine 6 is moved. It is thus possible with the present embodiment to adjust the image size without changing the position of the lower side of the screen.

Also, the position LC1 of the lower side of the screen 10 remains unchanged even if the projection image size is changed with the movement of the optical engine 6. It is thus possible, even if the projection image size is changed, to use the position LC1 of the lower side of the screen as a reference position to install the screen 10 on the wall surface 8. This consequently eliminates the need to increase the level of the installation position of the screen, as in Related Art A described above, even if the projection image size is increased, thus facilitating the attachment of the screen 10 onto the wall surface 8. It is also possible to use the position LC1 of the lower side as a reference position to install appropriate screens confirming to various projection image sizes.

Since the position LC1 of the lower side of the screen 10 remains unchanged even if the projection image size is changed, the projection image size can be adjusted continuously.

Note that if a screen corresponding to the largest projection image size is installed on the wall surface 8, that screen can be used for all projection image sizes by adjusting the position of the optical engine 6 using the adjustment member 11. In other words, it is sufficient that, when a single screen is used for all projection image sizes, the screen 10b is installed on the wall surface 8. Furthermore, the longitudinal length of the screen can be kept short if the position LC1 of the lower side of the screen is used as a reference position. This consequently makes it possible to reduce the cost of the screen and to dismiss the fear that the screen could interfere with the ceiling.

According to the present embodiment, the optical engine 6 moves within the casing 50 of the image projection apparatus 1000. Thus, the distance from the wall surface 8 to the front end of the image projection apparatus 1000 is constant. Accordingly, if the rack 7 that can well receive the image projection apparatus 1000 is used to install the image projection apparatus 1000, the image projection apparatus 1000 can be stably installed on the rack 7 even if the projection image size is changed.

Accordingly, the relative positions of the screen 10 and the optical engine 6 built into the image projection apparatus 1000 can be stabilized. In other words, the relative positions of the screen and the optical engine are accurately determined. This prevents the occurrence of distortion in a projection image on the screen 10 even if the projection image size is changed. As a result, it is possible to obtain an optimal image that gives the impression of high resolution.

The present embodiment illustrates a configuration that enables the user to access the optical engine 6 from the front of the image projection apparatus 1000, using a driver or the like. The user can thus easily adjust the projection image size.

In the present embodiment, as a result of loosening the adjustment member 11 (the screw) in the state in which the optical engine 6 is pushed by the adjustment member 11, the optical engine 6 moves in the direction of extension of the holes 5b by its own weight. This makes it possible to simplify the mechanism for adjusting the projection image size and consequently to reduce the cost required for the mechanism for adjusting the projection image size.

The image projection apparatus 1000 also includes an optical mechanism using the aspherical mirror 3. The optical engine 6 is thus disposed at a position below the lower side of the screen 10. This prevents the casing 50 containing the optical engine 6 from interfering with the region of the projection image when the user views the projection image from the front of the screen 10.

Note that Related Art A described above has the problem of the cost involved, since a screen having a large longitudinal dimension has to be used when displaying small- and large-size images on the same screen. In addition, the projection engine portion is installed along a direction perpendicular to the screen surface. Specifically, the projection engine portion is installed parallel to the floor surface. Thus, the mechanism for moving the projection engine portion requires a mechanism for pushing and pulling the projection engine portion. This requires additional members such as a spring within the casing, thus causing an increase in cost.

In Related Art B described above, the projection distance setting means for determining the interval (the projection distance) between the projection apparatus and the projection surface is provided at the back of the display system. The position of the projection apparatus can be moved by varying the angle of connection between each pair of rigid members in the projection distance setting means. Accordingly, the distance from the screen surface to the front end of the projection apparatus varies depending on the size of an image on the screen.

It is assumed that, with the above-described configuration, the projection apparatus is placed on the rack such that the position of the front end of the projection apparatus is in alignment with the front end of the rack when the image size is the smallest, for example. In this case, if the projection apparatus is moved away from the screen in order to increase the image size, the front end of the projection apparatus will extend beyond the rack. This lowers the visual quality and causes the projection apparatus itself to bend forward. As a result, there is a problem of distortion of the projection image on the screen.

More specifically, the forward bending of the front end of the projection apparatus increases the travel distance of the light beam directed toward the upper side of the screen. This causes downwardly tapered, vertical trapezoidal distortion. In addition, the projection distance setting means also has the problem of the cost involved, because it includes at least two projection distance setting means each constituted by a pair of rigid members that are connected so as to make the angle therebetween variable.

In Related Art C described above, the projector is installed at the intersection of the holes provided in the two connecting members. Accordingly, the position of the projector relative to the screen can only be adjusted stepwise, imposing a limitation on the adjustable image size.

In Related Art C, the amount of protrusion of the projector from the screen surface varies from screen size to screen size. It is assumed that, with the above-described configuration, the projector apparatus is placed on the rack such that the position of the front end of the projector apparatus is in alignment with the front end of the rack when the image size is the smallest, for example. In this case, if the projector included in the projector apparatus is moved away from the screen in order to increase the image size, the front end of the projector apparatus may extend beyond the rack, degrading visual quality.

In Related Art C, it is necessary, at the time of installing the projector, to temporarily dismount the projector from the connecting members before changing the position at which the connecting members are combined, and then to again install the projector on the connecting members. The installation is thus time-consuming. In addition, the connecting members are located at the lower portion of the screen and moves vertically to the screen surface. Accordingly, there is the problem that when the user installs the projector and then views an image from the front, the projector itself may interfere with the range of the image size, thus making it difficult for the user to view the image.

The present embodiment with the configuration as described above can solve the above problems with Related Arts A, B, and C.

### Second Embodiment

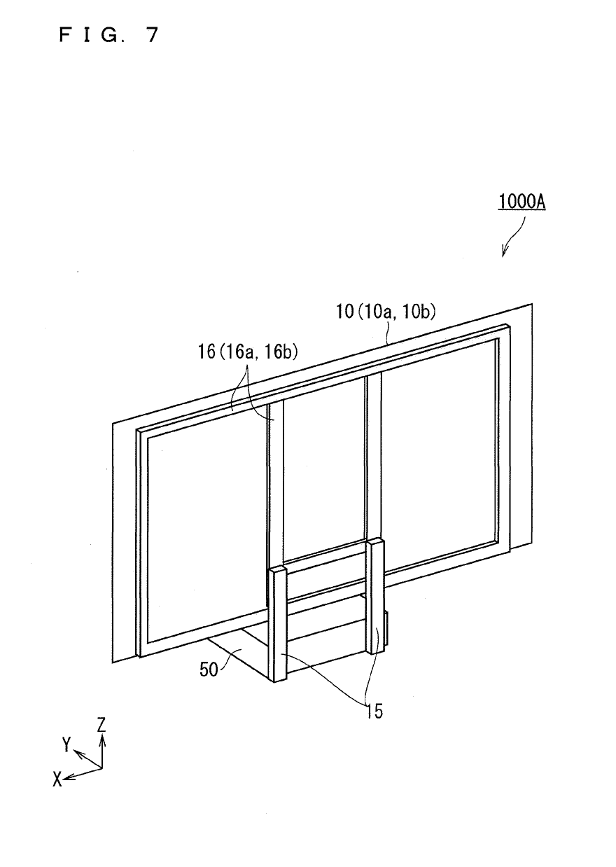

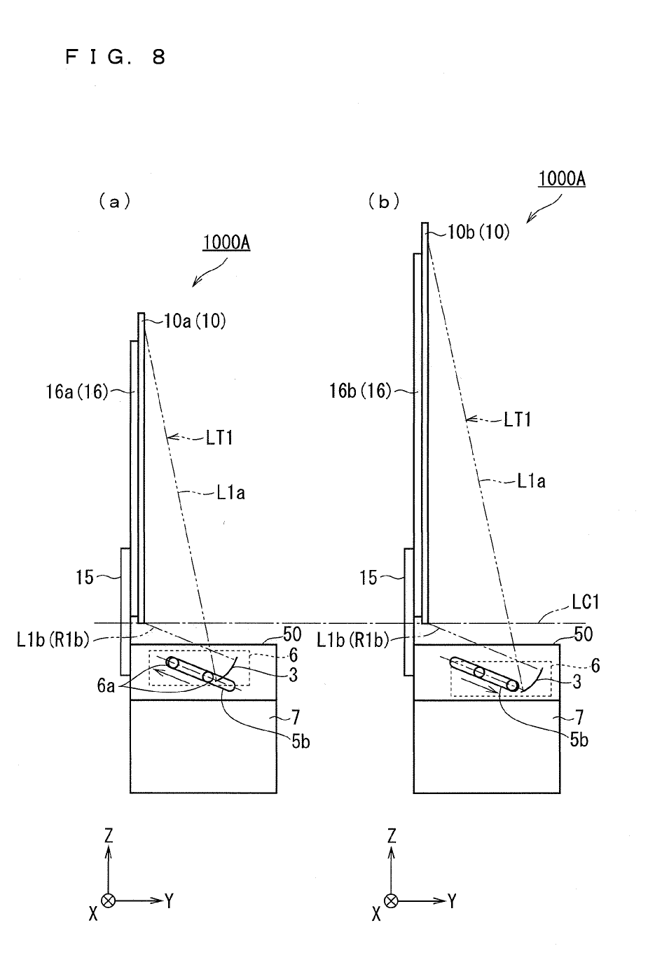

FIG. 7 is a perspective view of an image projection apparatus 1000A according a second embodiment of the present invention. FIG. 8 shows side views of the image projection apparatus 1000A according to the second embodiment of the present invention. Part (a) in FIG. 8 is a side view of the image projection apparatus 1000A using the screen 10a. Part (b) in FIG. 8 is a side view of the image projection apparatus 1000A using the screen 10b.

Referring to FIGS. 7 and 8, the image projection apparatus 1000A is different from the image projection apparatus 1000 in FIG. 1 in that it further includes the screen 10, a reinforcement frame 16, and a strut member 15. The other constituent elements of the image projection apparatus 1000A are the same as those of the image projection apparatus 1000, and therefore, a detailed description thereof will not be repeated. For the sake of simplification, FIGS. 7 and 8 do not show the top panel 12 and the front panel 13 that are included in the image projection apparatus 1000A.

The reinforcement frame 16 is a member for maintaining the planarity of the screen 10. The reinforcement frame 16 is formed in the shape of a frame using an adhesive material such as double-sided tape. The reinforcement frame 16 is fixed to the back surface of the screen 10 with the adhesive material.

The strut member 15 is a strength member for allowing the screen 10 to stand by itself. The strut member 15 has high rigidity. The strut member 15 is fixed to the reinforcement frame 16 and the casing 50. Specifically, the screen 10 provided with the reinforcement frame 16 is attached to the casing 50 using the strut member 15. In other words, the screen 10 is fixed to the casing 50 using the reinforcement frame 16 and the strut member 15. That is, the screen 10 and the casing 50 are integrated with each other.

The casing 50 housing the optical engine 6 is disposed below the lower side of the screen 10.

The strut member 15 serves to determine the positional relationship between the screen 10 and the casing 50 (i.e., the optical engine 6). Accordingly, an optimal image is shown on the screen 10.

Note that the casing 50 of the image projection apparatus 1000A has the same configuration as the casing 50 of the image projection apparatus 1000, and therefore a detailed description thereof will not be repeated. That is, the casing 50 of the image projection apparatus 1000A has a configuration in which the optical engine 6 is movable in the direction parallel to the path R1b of the light beam L1b.

As described above, the casing 50 housing the optical engine 6 is disposed below the lower side of the screen 10. That is, the optical engine 6 is configured to be movable below the lower side of the screen 10.

In the following, the reinforcement frame 16 provided on the back surface of the screen 10a is also referred to as a “reinforcement frame 16a”. In the following, the reinforcement frame 16 provided on the back surface of the screen 10b is also referred to as a “reinforcement frame 16b. The vertical length of the reinforcement frame 16b is larger than that of the reinforcement frame 16a.

Part (a) in FIG. 8 shows a state (hereinafter, also referred to as a “state N1a”) in which the optical engine 6 has moved toward the strut member 15. In the state N1a, the distance between the screen 10a and the optical engine 6 is the shortest. In the state N1a, the size of the image light LT1 (image) to be projected onto the screen 10a is the smallest.

Part (b) in FIG. 8 shows a state (hereinafter, also referred to as a “state N0a”) in which the optical engine 6 has moved to a position farthest away from the strut member 15. In the state N0a, the distance between the screen 10b and the optical engine 6 is the longest, and the projection image size on the screen 10b is the largest.

As described above, the casing 50 of the image projection apparatus 1000A has a configuration in which the optical engine 6 is movable in a direction parallel to the path R1b of the light beam L1b, as in the first embodiment. Accordingly, in the case of adjusting the projection image size, the projection image size can be continuously adjusted without changing the position LC1 of the lower side of the screen 10. The position LC1 of the lower side of the screen 10 remains unchanged even if the projection image size is changed. Accordingly, the reinforcement frame 16a or the reinforcement frame 16b can be fixed to the strut member 15 at the same level of position.

In other words, even if the projection image size changes and accordingly the sizes of the screen 10 and the reinforcement frame 16 change, the same strut member 15 fixed (connected) to the casing 50 can be shared. The position of the optical engine 6 can be continuously changed within the range of movement of the rod-like members 6a. Accordingly, an optimal image can be obtained if a screen onto which an image of a projection image size determined by the position of the optical engine 6 can be projected is attached to the strut member 15.

The projection image size is adjusted by the optical engine 6 moving within the casing 50. This eliminates the need to disassemble the casing 50, making it easy to adjust the projection image size, for example.

The distance from the screen 10 to the front end of the casing 50 is constant because the optical engine 6 moves within the casing 50. Accordingly, if the rack 7 that can well receive the casing 50 is used to install the casing 50, the casing 50 will not extend beyond the rack 7 even if the projection image size is changed. In other words, the casing 50 can be stably installed on the rack 7 even if the projection image size is changed.

The image projection apparatus 1000A also includes an optical mechanism using the aspherical mirror 3. The optical engine 6 is disposed below the lower side of the screen 10. This prevents the casing 50 containing the optical engine 6 from interfering with the area of the projection image when the user views the projection image from the front of the screen 10.

Next is a description of the method for moving the position of the optical engine 6 in the image projection apparatus 1000A.

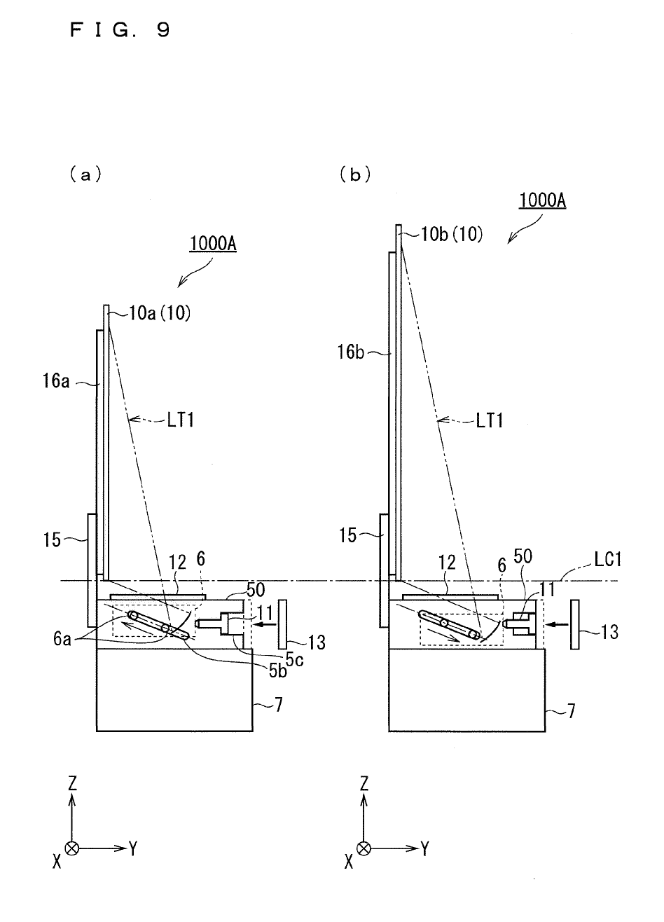

FIG. 9 shows side views of the image projection apparatus 1000A for illustrating the mechanism for adjusting the projection image size. For the sake of simplification, the protruding portion 6c provided on the front surface 6nf of the optical engine 6 is not shown in FIG. 9.

As in the first embodiment, the hole 5c formed in the front surface 5nf of the casing 50 enables the user to access the optical engine 6 from the front of the image projection apparatus 1000A, using a driver or the like. Note that the method for moving the position of the optical engine 6 is the same as that used in the first embodiment. Below is a brief description.

One end of the adjustment member 11 is in contact with the protruding portion 6c (the front surface 6nf) of the optical engine 6. By the user rotating the adjustment member 11 either clockwise or counter-clockwise using a driver or the like, the optical engine 6 is moved by the rod-like members 6a in the direction of extension of the holes 5b. This causes a change in the distance from the optical engine 6 to the screen 10. Accordingly, the size of an image to be projected onto the screen 10 is also changed.

Specifically, it is assumed that in the state N0a in part (b) in FIG. 8, the operation of rotating the adjustment member 11 clockwise from the front surface 5nf side of the casing 50 is performed by the user using a driver or the like. This causes the front surface 6nf (the protruding portion 6c) of the optical engine 6 to be pushed by the end of the adjustment member 11. Accordingly, the optical engine 6 moves in the direction of extension of the holes 5b. Note that the optical engine 6 is movable until the rod-like member 6a on the rear side come into contact with the ends of the holes 5b on one side.

The projection image size is the smallest when the rod-like members 6a are in contact with the ends of the holes 5b on one side. In this case, the user fixes the screen 10a corresponding to the projection image size to the strut member 15 via the reinforcement frame 16a. This determines the relative positions of the screen 10a and the optical engine 6. Accordingly, an optimal image can be obtained on the screen 10a.

It is also assumed that in the state N1 a in part (a) in FIG. 8, the operation of rotating the adjustment member 11 counterclockwise, for example, is performed by the user using a driver or the like. This causes the end of the adjustment member 11 to move in the direction of the front surface 6nf. Accordingly, the optical engine 6 being in contact with the end of the adjustment member 11 moves in the direction of the front surface 6nf along the holes 5b by its own weight. Note that the optical engine 6 is movable until the rod-like member 6a on the front side come into contact with the ends of the holes 5b on the other side.

More specifically, when the user rotates the adjustment member 11 counterclockwise using a driver or the like in the state N1a, the optical engine 6 moves in the direction of the front surface 6nf along the holes 5b by its own weight. That is, the position of the optical engine 6 (i.e., the projection image size) can by adjusted through a simple operation of loosening the adjustment member 11. It is thus possible to simplify the mechanism for adjusting the projection image size in the image projection apparatus 1000A and consequently to reduce the cost required for adjusting the projection image size.

The projection image size is maximum when the rod-like members 6a are in contact with the ends of the holes 5b on the other side. In this case, the user fixes the screen 10b corresponding to that projection image size to the strut member 15 via the reinforcement frame 16b. This determines the relative positions of the screen 10b and the optical engine 6. Accordingly, an optimal image can be obtained on the screen 10b.

Note that, as in the first embodiment, the front panel 13 is attached to the front surface 5nf of the casing 50 so as to cover the hole 5c. Thus, it is possible to cover the adjustment member 11 by the front panel 13 after adjustment of the projection image size. This enhances the design quality of the image projection apparatus 1000A. The front panel 13 can be removed in the case of adjusting the projection image size, so that the adjustment member 11 can be accessed using a driver or the like.

As described above, the image projection apparatus 1000A according to the present embodiment has a configuration in which the screen 10 is fixed to the casing 50 using the reinforcement frame 16 and the strut member 15. That is, the screen 10 and the casing 50 are integrated with each other. Thus, the size of the image projection apparatus 1000A can be reduced. Moreover, because the screen is fixed, the projection image size can be adjusted more accurately than a configuration in which the screen is separately provided.

According to the present embodiment, the position of the lower side of the screen 10 remains unchanged even if the projection image size is changed. It is thus possible to continuously adjust the projection image size. Moreover, even if the sizes of the screen 10 and the reinforcement frame 16 are changed, the same strut member 15 fixed (connected) to the casing 50 can be used. That is, the strut member 15 can be attached at the same position. In other words, the same strut member can be used for different screen sizes.

The casing 50 of the image projection apparatus 1000A has a configuration, as in the first embodiment, in which the optical engine 6 is movable in the direction parallel to the path R1b of the light beam L1b. Accordingly, the present embodiment can also provide the same effect as that obtained by the first embodiment. That is, the image size can be adjusted without changing the position of the lower side of the screen.

According to the present embodiment, the optical engine 6 moves within the casing 50 of the image projection apparatus 1000A. Thus, even if the projection image size is changed, the image projection apparatus 1000A can be stably installed on the rack 7. In other words, the relative positions of the screen 10 and the optical engine 6 can be accurately determined. In addition, the relative positions of the screen 10 and the optical engine 6 can be accurately determined via the strut member 15. This prevents the occurrence of distortion in a projection image on the screen 10 even if the projection image size is changed. As a result, it is possible to obtain an optimal image that gives the impression of a high resolution.

In the present embodiment, the projection image size is adjusted by the optical engine 6 moving within the casing 50, as in the first embodiment. This eliminates the need to disassemble the casing 50 and makes it easy to adjust the projection image size.

The distance from the screen 10 to the front end of the casing 50 is constant since the optical engine 6 moves within the casing 50. If the rack 7 that can well receive the casing 50 is used to install the casing 50, the casing 50 will never extend beyond the rack 7 even if the projection image size is changed. In other words, the casing 50 can be stably installed on the rack 7 even if the projection image size is changed.

As in the first embodiment, the present embodiment has a configuration that enables the user to access the optical engine 6 from the front of the casing 50, using a driver or the like. The user can thus easily adjust the projection image size.

In the present embodiment, the optical engine 6 moves in the direction of extension of the holes 5b by its own weight as a result of loosening the adjustment member 11 (the screw) in the state in which the optical engine 6 is pushed by the adjustment member 11, as in the first embodiment. This makes it possible to simplify the mechanism for adjusting the projection image size and consequently to reduce the cost required for the mechanism for adjusting the projection image size.

As in the first embodiment, the image projection apparatus 1000A also includes an optical mechanism using the aspherical mirror 3. The optical engine 6 is thus disposed below the lower side of the screen 10. This prevents the casing 50 containing the optical engine 6 from interfering with the region of the projection image when the user views the projection image from the front of the screen 10.

It should be noted that the embodiments of the present invention may be freely combined or may be appropriately modified or omitted within the scope of the invention.

For example, the configuration in which the optical engine 6 is movable in the direction parallel to the path R1 b of the light beam L1b is not limited to the above-described configuration using the rod-like members 6a. For example, a configuration is also possible in which elongated holes are provided in the side surfaces of the optical engine 6, and rod-like members to be inserted into these holes are provided on the side surfaces 5n of the casing 50.

While the above-described embodiments illustrates a configuration in which the position of the optical engine 6 can be adjusted from the front surface of the casing 50, the present invention is not limited thereto. For example, a configuration is possible in which the position of the optical engine 6 can be adjusted from a side surface of the casing 50. While the above-described embodiments have a configuration in which the hole for use in adjusting the position of the optical engine 6 is provided in the front surface of the casing 50. The present invention is, however, not limited thereto, and such a hole for use in adjusting the position may be provided in a side surface of the casing 50, for example.

The number of rod-like members 6a provided on each side surface 5n of the casing 50 is not limited to two, and for example, one or three or more rod-like members 6a may be provided.

The image projection apparatuses 1000 and 1000A may be configured without the front panel 13.

The image projection apparatuses 1000 and 1000A may be configured without the top panel 12.

While the invention has been shown and described in detail, the foregoing description is in all aspects illustrative and not restrictive. It is therefore understood that numerous modifications and variations can be devised without departing from the scope of the invention.

What is claimed is:

1. An image projection apparatus for projecting an image onto a screen, comprising:
an optical engine configured to emit image light constituting said image; and
a casing having a configuration in which said optical engine is movable in a direction parallel to a path of a bottom light beam of said image light, said bottom light beam being directed toward a lower side of said screen.

2. The image projection apparatus according to claim 1, wherein
said casing houses said optical engine.

3. The image projection apparatus according to claim 2, wherein
said casing has a hole that allows an adjustment member for adjusting a position of said optical engine to come into contact with said optical engine from outside said casing.

4. The image projection apparatus according to claim 1, wherein
said casing has a side surface provided with an elongated guide mechanism extending in a direction parallel to said path, and
said optical engine is provided with a guided mechanism for, in cooperation with said guide mechanism, allowing said optical engine to be movable in the direction of extension of said guide mechanism.

5. The image projection apparatus according to claim 1, further comprising
said screen that is fixed to said casing.
